(19) United States
(12) Patent Application Publication
(10) Pub. No.: US 2009/0325790 A1
(43) Pub. Date: Dec. 31, 2009

(54) SIZE-CONTROLLABLE TRANSITION METAL CLUSTERS IN MCM-41 FOR IMPROVING CHEMICAL CATALYSIS

(75) Inventors: Gary L. Haller, Hamden, CT (US); Sangyun Lim, Kingwood, TX (US); Dragos Ciuparu, Ploiesti (RO); Yuan Chen, New Haven, CT (US); Yanhui Yang, New Haven, CT (US); Lisa Pfefferle, Branford, CT (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Yale University, New Haven, CT (US)

(21) Appl. No.: 11/630,023

(22) PCT Filed: Jun. 17, 2005
(86) PCT No.: PCT/US2005/021839

§ 371 Date: Nov. 6, 2008

Related U.S. Application Data
(60) Provisional application No. 60/581,013, filed on Jun. 17, 2004.

(51) Int. Cl. B01J 21/08

(52) U.S. Cl. 502/241; 502/240; 502/242; 502/244; 502/247; 502/256; 502/258

(57) ABSTRACT

A metal-substituted mesoporous oxide framework, such as Co-MCM-41, are disclosed which includes more than one ion species with different reduction kinetics. The reducibility correlates strongly with the pore radius of curvature, with the metal ions incorporated in smaller pores more resistant to complete reduction. The metal-ion substituted oxide framework improves catalytic processes by controlling the size of the catalytic particles forming in the pores. The metal-substituted mesoporous oxide framework can be employed in selective hydrogenation of organic chemicals, in ammonia synthesis, and in automotive catalytic exhaust systems.

### FIELD OF THE INVENTION

The disclosed invention relates to methods for producing compositions of matter that substantially improve metal catalysis, increase catalyst or absorbent site density and dispersion, and enhance thermal stability. More particularly, the invention relates to producing metal-substituted MCM-41 with controlled pore diameter and with highly dispersed transition metal-ions in the pore walls which are stable at high temperatures. The invention is also directed to use of an oxide structure produced with the method in chemical catalysis, in particular hydrocarbon reforming.

### BACKGROUND OF THE INVENTION

Numerous research results on the physicochemical properties of M41S materials have been published since the discovery by a group of scientists at Mobil over a decade ago. MCM-41, a member of the M4IS family, has been widely investigated because of the relative ease of synthesis, a simple and size controllable pore structure, and the substitutability of Si by a broad range of metal ions for catalytic applications.

Most studies of the physical properties of MCM-41 have focused on the siliceous MCM-41 with a view toward material science. For catalytic applications, however, the chemical properties will be important as well as the physical properties. By incorporation of metal ions in the silica framework, MCM-41 can have catalytic activity that depends on the state of the metal component on the surface or in the framework. No strategy to control the location and structure of the active component in MCM-41 has been reported. However, such strategy would be valuable for the design of catalysts for specific reactions to optimize the catalytic activity.

There are several factors that affect the physical structure of MCM-41, for example, the mole ratio of each component in the synthesis solution, autoclaving time and temperature, pH, and silica source. However, when designing an effective catalyst, for example metal-incorporated MCM-41, not only the physical structure (surface area, porosity, etc.) needs to be considered, but also the particular location of the metal component in the MCM-41 structure. Reduction patterns of Co-MCM-41 have been found to be sensitive to calcination conditions, impurity level of silica source, the pore diameter of the MCM-41, and the initial pH of the synthesis solution.

The purity level of the silica synthesis source and calcinations conditions can be addressed by using a highly pure silica source (Cab-O-Sil: >99.8% SiO₂) and the same (small) amount of catalyst with a low ratio of catalyst to gas flow rate for all calcinations.

While the foregoing arrangements are adequate for a number of applications, there is still a need for a process that can predictably control the pore size of metal-substituted MCM-41 and the distribution of the metal ions in the pores or pore walls and can produce a metal-substituted MCM-41 with ultra-small metal clusters that is stable under various reducing conditions.

### SUMMARY OF THE INVENTION

The invention addresses the deficiencies of the prior art by, in various embodiments, providing methods for producing metal-substituted mesoporous oxide frameworks, such as Co-MCM-41, with different pore diameters, which are resistant to thermal reduction.

According to one aspect of the invention, a method for producing a mesoporous structure containing metal ions dispersed in the structure includes adding a surfactant to an aqueous solution containing a source of silicon and of the metal ions, and maintaining a pH level of the aqueous solution at a value greater than 11.

With this selection of synthesis parameters, a large number of mesopores is produced on the structure with finely dispersed metal ions that resist reduction and are suitable for use in catalytic chemical processes.

The mesoporous structure can be a siliceous structure selected from the M41S class of materials, in particular MCM-41 and MCM-48, or an aluminum or zirconium oxide structure. The surfactant, for example CₙH₂ₙ₊i(CH₃)₃NBr with n=10, 12, 14, 16 and 18, can have a predetermined alkyl chain length, wherein the radius of curvature can be correlated with the alkyl chain length. An anti-foaming agent can also be added to the aqueous solution.

Advantageously, the dispersed metal ions having a spatial distribution in the structure that depends on a radius of curvature of the pores of the structure. In particular, the dispersed metal ions are resistant to sintering or clustering, if the pores have a large radius of curvature. Moreover, the metal-substituted mesoporous structure is resistant to reduction if the pores have a large radius of curvature.

The metal ion comprises metal ions can be selected from the first row transition metals or from the Group VIII of the periodic system, in particular Cu, Ti, V, Cr, Mn, Fe, Co, Ni. Their concentration in the aqueous solution can be adjusted to satisfy certain desired structural parameters of the metal-substituted mesoporous structure.

Advantageously, the area density of mesopores having a diameter of less than about 10 nm increases with increasing pH level.

According to yet another advantageous embodiment, more than one metal species can be added to the aqueous solution. For example, a first metal ion species can be added and dispersed in the structure, whereafter a second metal ion species is added. The first ion species functions as an “anchor” for the second metal ion species, thereby reducing the size of second ion particles formed on or in the pores of the structure. Preferably, the second metal ion species, for example Fe, Ni or Co, is less reducible than the first metal ion species, for example Ti or Zr.

The invention is also directed to an ordered mesoporous oxide structure produced with the aforedescribed method, and a use of an oxide structure produced with the method in chemical catalysis, in particular hydrocarbon reforming.

According to another aspect of the invention, a method for modeling a process for producing a mesoporous structure containing metal ions includes the steps of selecting characteristic features of the desired mesoporous structure, in particular pore size, metal incorporation and structural order, selecting a plurality of synthesis parameters associated with a plurality of structures produced with the aforedescribed method, and performing a statistical analysis which takes into account two-way interactions between the synthesis parameters, to predict the characteristic features from the synthesis parameters.

Further features and advantages of the present invention will be apparent from the following description of illustrative embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows experimental results obtained by temperature programmed reduction (TPR) on Co-MCM-41 samples prepared using surfactants with different chain length;

FIG. 2 shows changes in the reduction temperature of Co-MCM-41 samples as a function of pore diameters;

FIG. 3 shows the area of the deconvoluted reduction peak of Co-MCM-41 samples as a function pore diameter;

FIG. 4 shows the average first shell Co-Co coordination number vs. cluster diameter created by the cobalt (111)-truncated hemispherical cuboctahedron model;

FIGS. 5(a) to 5(c) show a comparison of the physical properties obtained from nitrogen physisorption between the C16 Co-MCM-41 samples prepared under different pH conditions;

FIGS. 6(a) and 6(b) show a TEM of Co-MCM-41 prepared using two different pH values;

FIG. 7 shows TPR profiles of C16 Co-MCM-41 samples prepared using different pH values. The inset shows the maximum reduction rate as a function of pH;

FIGS. 8(a)-8(c) show a deconvolution of the TPR profiles of three C16 Co-MCM-41 samples of FIG. 7 for pH values of 11, 11.5, and 12;

FIGS. 9(a)-(c) show normal quantile plots of structural order (a), cobalt concentration (b), and pore diameter (c);

FIG. 10 shows a comparison between predicted value and experimental results of structural order, pore diameter and cobalt concentration;

FIG. 11 shows an exemplary pictorial diagram of the size/distribution of Co particles on the surface of metal-ion substituted MCM-41; and

FIGS. 12(a) and (b) show the apparent Co metal cluster size as a function of the reduction time for Co- and Ti-substituted MCM-41.

### DETAILED DESCRIPTION OF CERTAIN ILLUSTRATED EMBODIMENTS

The invention is directed to methods for generating novel compositions of matter that substantially improve metal catalysis, enhance catalyst, absorbent, or absorbent dispersion, and improve thermal stability. In particular, the invention is directed to a process for producing a metal-substituted mesoporic siliceous framework, such as a MCM-41 framework, with a controlled small pore size, to the control of such process, and to models for predicting the physical and chemical structure of the metal-substituted MCM-41 framework from experimental growth parameters. The invention is also directed to novel compositions of matter produced by the process and to the use of the compositions of matter in, for example, chemical catalysis.

The experimental parameters used herein, such as temperatures, reaction times and pH values, are approximate only and can vary within a generally accepted measurement accuracy.

The process is suitable for the preparation of size-controllable sub-nanometer transition metal clusters, on a high area silica support. The exemplary silica support is the material MCM-41 with surface areas of the order of 1000 square meters per gram. The process uses the hydrothermal synthesis of a metal-containing MCM-41, e.g., Co-containing Co-MCM-41, under conditions that result in isomorphous substitution of the metal for Si at low weight loadings in the range of 0.01 to 10 wt %, more specifically in the range of 0.1 to 5 wt %. Among the various synthesis parameters, e.g., silica source, Si/surfactant ratio, Si/water ratio, etc., the pore size of the MCM-41 and the initial pH of the synthesis solution are important parameters to control the size of the metal clusters. Other group VIII transition metals (Cu, Fe, Co, Ni, Ru, Rh, Pd, Os, Ir, Pt) in general, and first-row group VIII transition metals, in particular, can be used. It is known to those skilled in the art that the pore size of MCM-41 can be varied by varying the alkyl chain length of the templating surfactant. The metal cluster size is further controlled by the time, temperature and reductant used to reduce the transition metal cation isomorphously substituted for Si in the MCM-41 matrix. The smallest metal clusters result from a partial reduction of the cations to metal.

However, it is still difficult to incorporate many metals with a high degree of dispersion, usually defined as the percent of the metal exposed on the surface because the small metal clusters tend to migrate and sinter to make larger metal particles. For example, conventionally prepared Co supported on silica for applications in Fischer-Tropsch Synthesis has been reported to have dispersions in the range of 10-30 percent, while the disclosed process can produce dispersions of 100%. The high dispersions are also thermally stable to high temperatures, e.g., in excess of 500° C., which is quite unusual, particularly for first-row transition metals.

According to one aspect of the invention, the catalytic activity of metal-substituted mesoporous molecular sieve (MCM-41) templates is affected by the radius of curvature of the pore walls. Processes are provided to affect and control the radius of curvature of the template pore walls, in particular by selecting surfactants with a predetermined chain length which correlates with the radius of curvature and by adjusting the pH level of the growth conditions of the template.

The low hydrothermal and mechanical stability of the metal substituted MCM-41 materials has been a major drawback in using them as catalysts. By modifying the original synthesis conditions, i.e., mixing effect, pH, anti-foaming agent, silica source, autoclaving temperature and time, etc., some of these physical problems have been addressed in the past. However, the distribution of isomorphously substituted metal components in MCM-41, which may substantially affect the catalytic activity and stability, is still difficult to control. Co-MCM-41 is quite stable against redox cycles at high temperatures (900° C.) under oxidation conditions due to the formation of cobalt orthosilicate on the surface at 850° C. It was therefore found to be advantageous to incorporate the metal component in the MCM-41 framework with quasi-atomic scale dispersion to prevent cobalt sintering. This procedure allows the stabilization of ultra-small metal clusters. Temperature programmed reduction (TPR) and X-ray absorption (XANES and EXAFS) have been used as experimental tools to investigate the stability of the Co-incorporated MCM-41 with different pore sizes under a variety of reducing conditions. Co-MCM-41 with five different average pore diameters ranging from 1.8 to 3.1 nm, as measured by the BJH method (Barrett, E. P.; Joyner, L. G.; Halenda, P. P. Journal of the American Chemical Society 1951, 73, 373), was prepared.

For studying the pore radius of curvature effect, Co-MCM-41 samples with the surfactants C10-C18 were synthesized by mixing fumed silica (Cab-O-Sil, Cabot Corporation), tetramethylammonium silicate (16.9% TMASi, Aldrich), de-ionized water, and cobalt sulfate (Adlrich) aqueous solution for 30 min. C10-C18 refers to CₙH₂ₙ₊₁(CHs)₃NBr), wherein n=10, . . . , 18. The water-to-total-silica mole ratio was set at 86 for all samples. The surfactant solutions C10-C18 were added to the prepared silica and Co mixture, and a small amount of anti-foaming agent (0.2 wt % of surfactant) was incorporated to remove excess foam produced by the surfactant as a result of vigorous stirring of the synthesis solution. Acetic acid (Baker) was added until pH=1 1.5 was reached. After additional mixing for about 30 min, this synthesis solution was poured into a polypropylene bottle and placed in the autoclave at 100° C. for 6 days. After cooling to room temperature, the resulting solid was recovered by repeated filtration and washing with de-ionized water, and dried under ambient conditions overnight. The pre-dried solid was then heated from room temperature to 540° C. for 20 hours under ultra-high purity He (30 ml/min) and soaked for 1 hour at 540° C. in flowing He followed by calcination for 6 hrs at 540° C. under flowing ultra-zero grade air to remove residual organics. The molar ratio of each component in the synthesis solution was fixed at a SiO₂:surfactant:Co:H₂O molar ratio of 1:0.27:0.01:86. Because the preparation process may cause some loss of Co and silica in the by-products, the final Co content of each sample was determined by ICP. The physicochemical properties of the prepared Co-MCM-41 samples were characterized by XRD, nitrogen physisorption, UV-vis, X-ray absorption, and TEM.

The reducibility and the stability of C10-C18 Co-MCM-41 samples prepared were investigated by a temperature programmed reduction (TPR) technique using the thermal conductivity detector (TCD) of a gas chromatography apparatus. Approximately 200 mg of each sample was loaded into a quartz cell. Prior to each TPR run, the sample cell was purged by ultra zero grade air at room temperature, then the temperature was increased to 500° C. at 5° C./min, soaked for 1 hour at the same temperature, and cooled to room temperature. This procedure produces a clean surface before running the TPR. The gas flow was switched to 5% hydrogen in argon balance, and the base line was monitored until stable. After baseline stabilization, the sample cell was heated at 5° C./min and held for 1 hour at 900° C. to ensure complete cobalt reduction. An acetone trap was installed between the sample cell and the TCD to condense water, produced by sample reduction.

As a complementary experiment to TPR and for the measurement of Co cluster size, in-situ and ex-situ X-ray absorption measurements were performed at the Co K-edge (7709 eV). To characterize the effect of the reduction temperature, each sample was reduced at 500° C. and 700° C. by flowing ultra-high purity hydrogen for 30 minutes to 1 hour and then quenched at 0° C. X-Ray absorption near edge structure (XANES) spectra were collected during sample reduction with a 5 min interval between scans. Extended X-ray absorption fine structure (EXAFS) spectra were also recorded for the measurement of Co cluster sizes of samples after each sample treatment described above. Because the samples were exposed to air after TPR, a mild reduction at 400° C. for 30 min was carried out to reduce the partially oxidized Co prior to recording the EXAFS spectra.

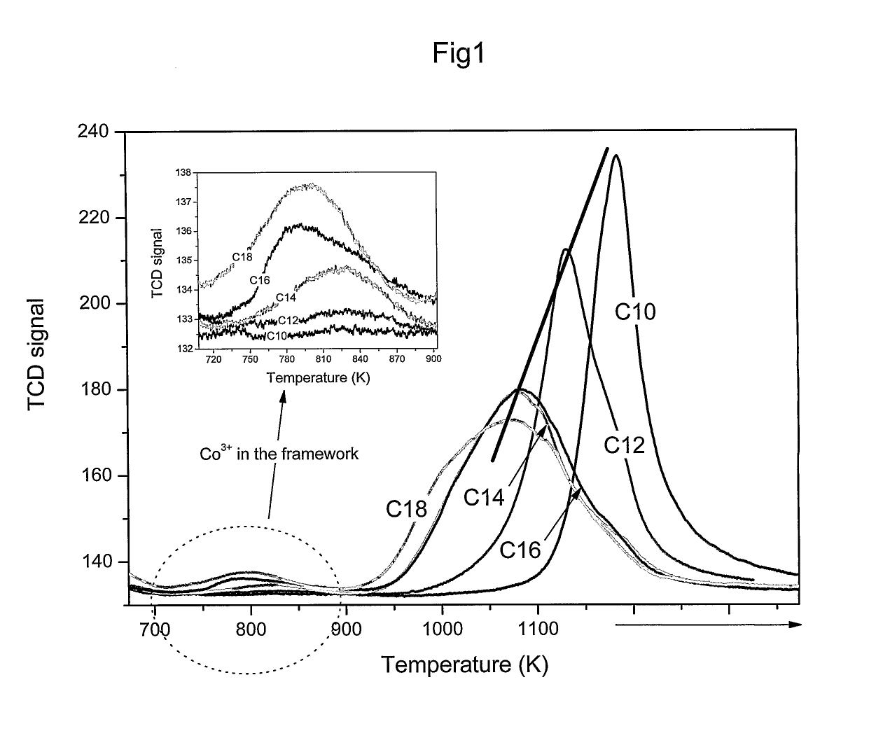

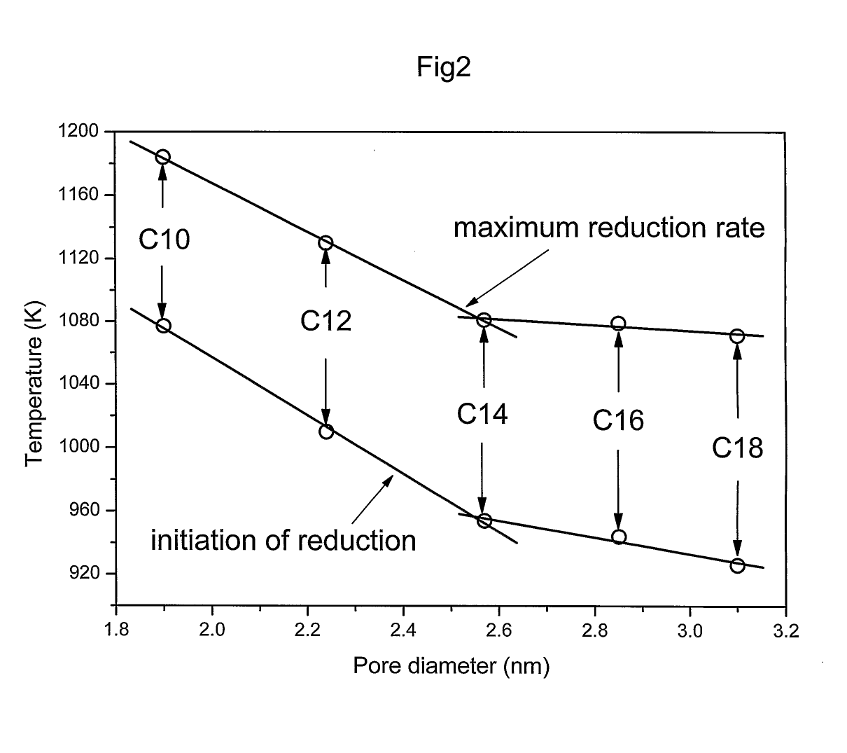

FIG. 1 shows temperature programmed reduction (TPR) profiles for samples having the same cobalt loading but different pore diameters. Co-MCM-41 samples having different pore diameters show different reduction patterns. There are no reduction peaks under 400° C., suggesting that Co is entirely incorporated into the silica framework. In addition, there is a systematic change in the temperature at the maximum reduction rate (summit of the peak) and in the temperature of reduction initiation. Both of these temperatures decrease linearly with increasing pore size. These two temperatures are plotted for clarity against the pore diameter in FIG. 2. A mechanism that might explain this observation is the change in silica structure at high radius of curvature (small pore size). A smaller ring structure in small pores is more difficult to break than larger rings in large pores, when some of the Si atoms are substituted by Co atoms in the Co-MCM-41, thus resulting in a higher reduction temperature for cobalt incorporated in smaller pore diameter MCM-41.

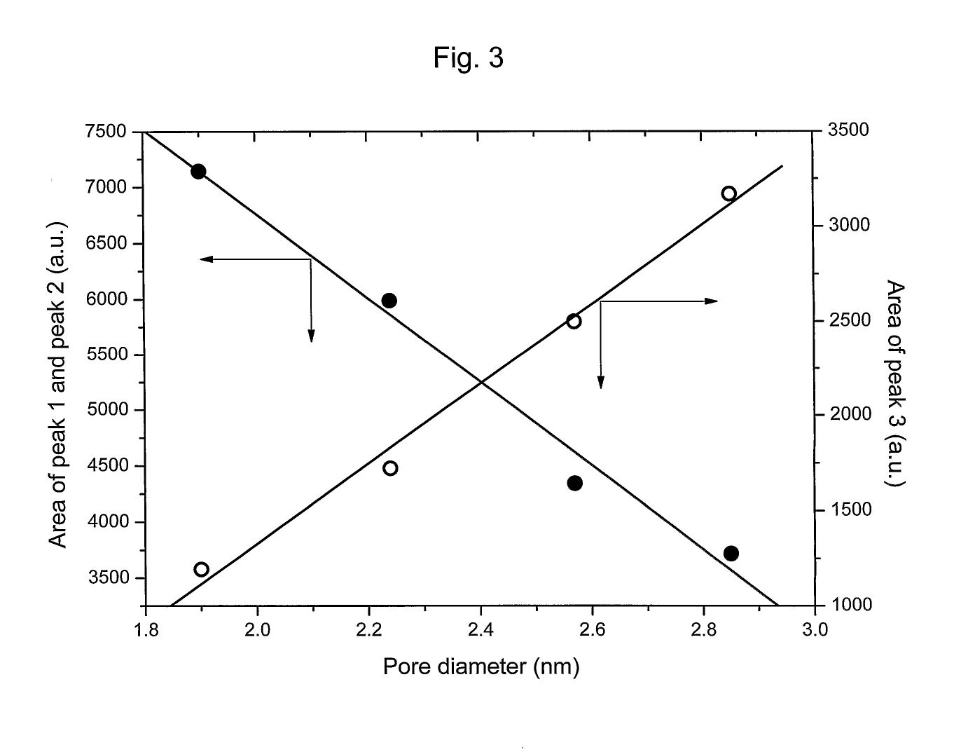

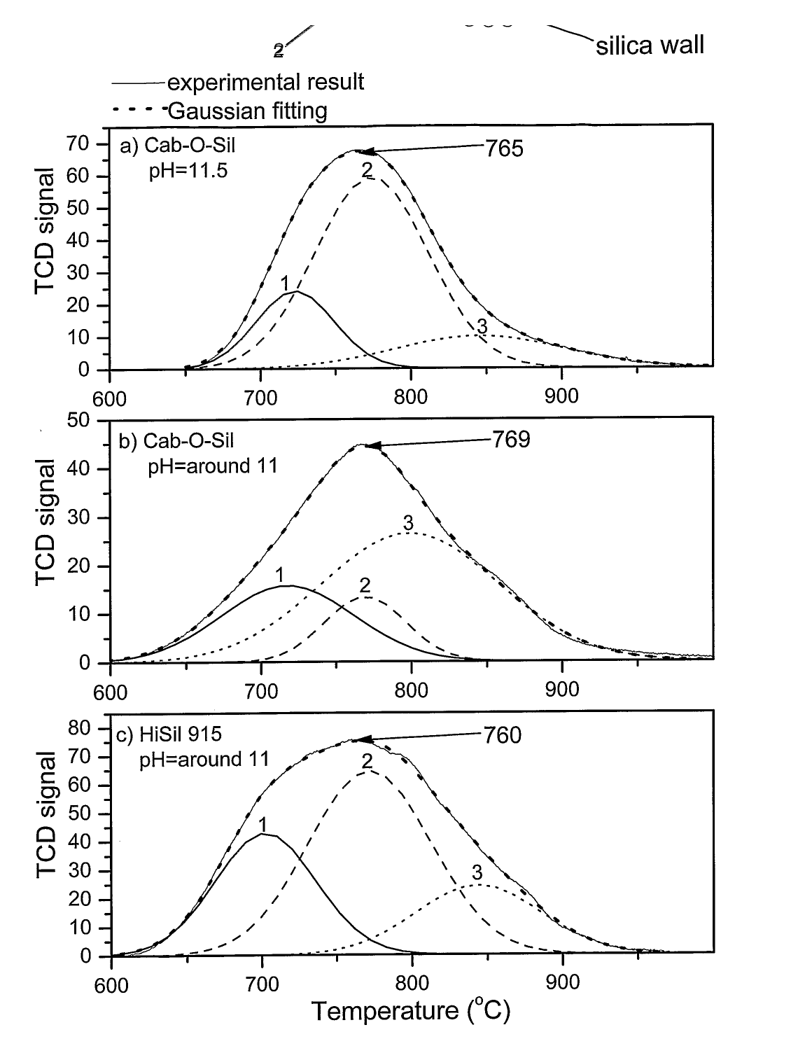

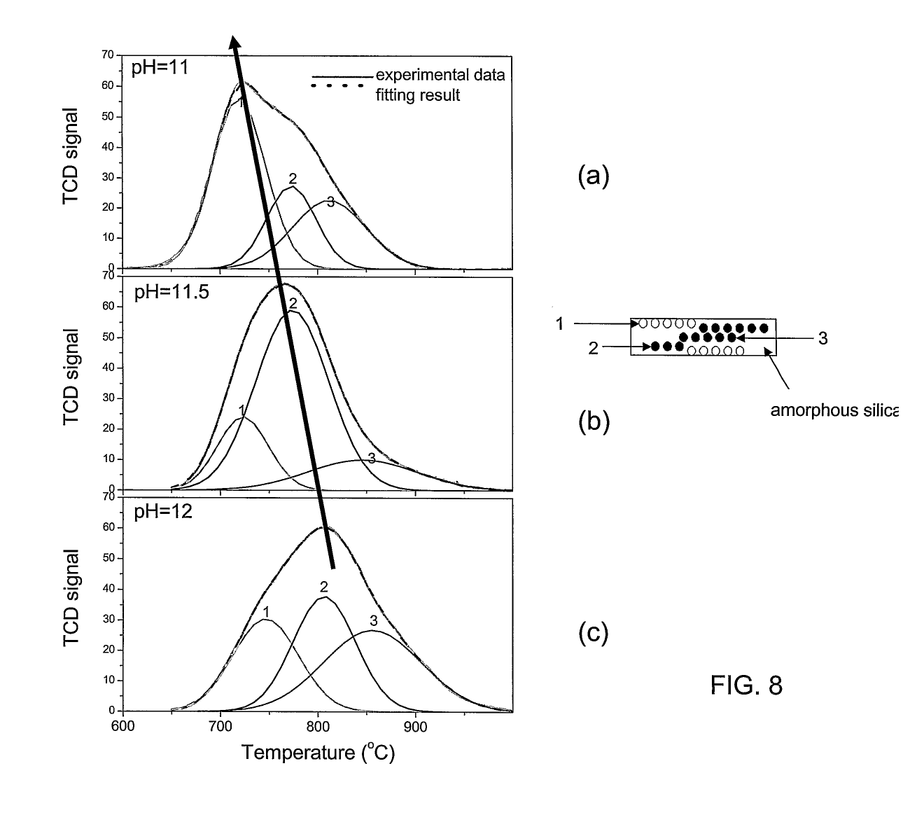

The location of the Co ions in the MCM-41, e.g., at the pore wall surface, near the pore wall surface or in the “bulk” of the 1 nm thick pore walls, may also have an effect on the reduction temperature. Cobalt near the pore wall surface is expected to be more easily reduced than that cobalt located in the bulk, as expressed in a higher rate of reduction. With an assumed constant pore wall thickness of 1 nm and a calculated Co²⁺ ionic radius of 0.072 nm for Co incorporated and dispersed in the silica framework on an atomic scale, several layers of Co may exist, for example, at or near the surface of the pore wall, in the center of the wall, and between these locations. Taking into account the location of Co ions in the MCM-41 pore walls, the slight asymmetry of the Co²⁺ reduction peak of the TPR profiles can be deconvoluted into three Co²⁺ reduction peaks, with the integrated peak area (assigned as peak 1, 2, and 3) plotted against the pore size in FIG. 3. Reference for the designation of the peaks 1, 2, 3 is also made to FIGS. 5 and 8, which show a similar deconvolution for samples prepared on different substrates and with different pH values, respectively. Peaks 1 and 2 are assumed to be Co ions distributed near the pore wall surface, which can be reduced more easily than Co ions in the middle of the pore walls (bulk silica, peak 3). The amount of surface Co ions increases as the pore size of the Co-MCM-41 decreases, resulting in less Co buried in the silica bulk. The reduction rate of the surface Co should be much faster than those in the bulk, resulting in narrower and taller reduction peaks.

The TPR experiments above are evidence of a linear correlation between the pore radius of curvature and the Co reduction temperatures. It is of interest, for many potential applications in catalysis, to determine if the size of the cobalt clusters formed in the MCM-41 silica matrix is also influenced by the pore radius of curvature. It can be expected that, as during synthesis of single wall carbon nanotubes in Co-MCM-41 catalysts of different pore diameters, the size of cobalt clusters obtained by reduction of the cobalt incorporated by isomorphous substitution of Si in the MCM-41 framework would also correlate with the pore size of MCM-41.

X-ray absorption spectroscopy was employed to characterize the changes in the local coordination of the Co in the Co-MCM-41 samples with different pore sizes at different stages in the reduction process. The size of the cobalt clusters was determined from the EXAFS spectra considering the average first shell Co-Co coordination number for each sample. The XANES spectra recorded for fresh C10-C18 Co-MCM-41 samples dehydrated at 500° C. for 30 min under flowing air (not shown) are super-imposable. The pre-edge peak is similar to that observed for CoAl₂O₄, confirming the tetrahedral coordination of the cobalt ions surrounded by oxygen anions in the pore walls.

TABLE 1

Co—O Coordination number

| Samples | Dehydrated | Hydrated |
|---|---|---|
| C10 Co-MCM-41 | 4.67 | 5.48 |
| C12 Co-MCM-41 | 4.63 | 5.65 |
| C14 Co-MCM-41 | 4.52 | 5.78 |
| C16 Co-MCM-41 | 4.49 | 5.78 |
| C18 Co-MCM-41 | 4.04 | 5.19 |

Table 1 shows the average first shell Co-O coordination numbers in dehydrated as well as in hydrated samples. In dehydrated samples, the coordination numbers systematically increase from about 4.0 to about 4.7 as the pores size decreases, suggesting the Co ions are incorporated in the silica framework by isomorphous substitution of Si without formation of any surface cobalt oxide compounds. The higher coordination numbers in the hydrated samples is also consistent with the proposed explanation for the increased coordination number for smaller pore diameters discussed above and may be attributed to water molecules.

An analysis of XANES experiments (not shown) indicates that the degree of reduction of Co atoms increases with the pore diameter of Co-MCM-41 samples, as would be predicted. More than half of the Co atoms are still oxidized in the framework after reduction by pure hydrogen at 700° C. for 30 minutes. The C10 and C12 Co-MCM-41 samples having the smaller pore size (large radius of curvature) are essentially unreduced even after this severe reduction condition. After CO disproportionation at 800° C. for 1 hour, however, more Co atoms are reduced; 95% of the Co atoms are reduced in the C18 Co-MCM-41 sample.

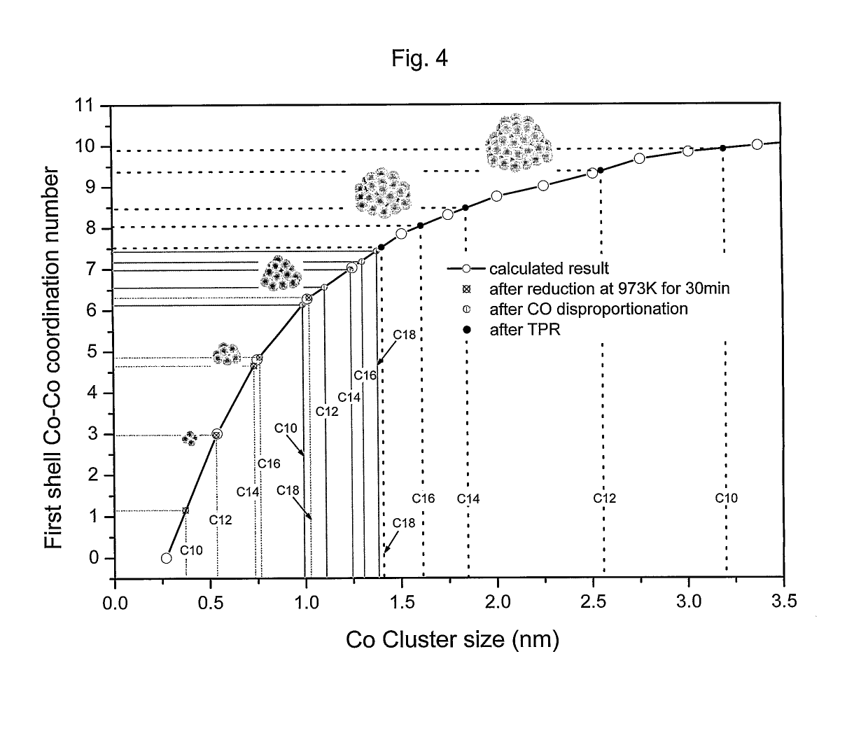

The Co-Co first shell coordination numbers obtained from the EXAFS spectra (see Table 1) were used to determine the approximate size of the cobalt clusters formed during each treatment. A (111)-truncated hemispherical cuboctahedron model was built to correlate the cobalt clusters diameter with the average first shell coordination number, as shown in FIG. 4. The samples reduced by hydrogen at 700° C. for 30 minutes show the Co cluster size under 1 nm for all pore sizes. After CO disproportionation, all Co clusters are in the range of 1-1.5 nm, which is the narrowest window of cluster size distribution among the treatments described above. The EXAFS spectra provide a volume average coordination number, including the large particles on the surface. However, these number have not been corrected for the degree of reduction. The actual metallic clusters in the Co-MCM-41 pore, therefore, may be smaller than the ones predicted here. This suggests the possibility of producing sub-nm Co clusters by proper treatments, and the size of clusters can be precisely controlled by combining the treatment methods and the pore size of the Co-MCM-41 samples, and their stabilities may be improved by anchoring to Co ions in the silica matrix.

The structural properties and distribution of Co ions are not only affected by the pore size and pore wall curvature, as discussed above, but also by the pore structure, which can be changed by pH adjustment of the initial synthesis solution. Co-MCM-41 catalysts with the same pore size but greater porosity were synthesized with increasing pH from 10.5 to 12. The distribution of Co ions with respect to the pore wall in the silica framework changes with pH; higher pH produced Co ions mainly distributed just subsurface or in the interior of the silica wall. These pH effects significantly affect the reduction stability of the Co-MCM-41 sample similar to that of the pore radius of curvature effect described above. Changing the pH value can produce stable and size-controllable sub-nanometer Co clusters that are useful for catalyst design for specific reactions.

Cobalt-substituted MCM-41 was prepared using hexadecyltrimethylammonium hydroxide as a template material. Each sample's pH was adjusted to 10.5, 11.0, 11.5, 12.0, and 12.5 before autoclaving, and will be referred to hereinafter as C105, C110, C115, C120, and C125, respectively. In order to investigate the effect of calcination conditions on Co reducibility, varying amounts of each of the as-synthesized samples were used in test calcinations at a constant flow rate of helium and air. The effect of impurity in the silica source was also studied by simulating the low purity silica by adding 2.5 wt % NaCl and 0.5 wt % Na₂SO₄, natural impurities in HiSiI 233 and HiSiI 915, respectively, which are often used as silica sources for MCM-41 synthesis.

As before, the reduction stability of the Co-MCM-41 samples was investigated by a temperature programmed reduction (TPR) technique using a thermal conductivity detector (TCD). Approximately 200 mg of each sample was loaded into a quartz cell. Prior to each TPR run, the sample cell was purged by ultra zero grade air at room temperature, then the temperature was increased to 500° C. at 5° C. /min, the sample soaked for 1 hour at the same temperature, and then cooled to room temperature. This procedure produces a clean surface before running the TPR experiment. The gas flow was switched to 5% hydrogen in argon balance, and the base line was monitored until stable. After baseline stabilization, the sample cell was heated at 5° C. /min and held for 1 hour at 900° C. to ensure complete cobalt reduction. Water produced by sample reduction was condensed in an acetone trap installed between the sample cell and the TCD.

The pore size distributions were calculated, as before, from nitrogen desorption isotherms using the BJH method (Barrett, E. P.; Joyner, L. G.; Halenda, P. P. Journal of the American Chemical Society 1951, 73, 373). Although the BJH method under-estimates the mesopore size, the pore size distribution determined in our study provides reliable results that can be used for the relative comparison of the synthesized samples.

The TPR patterns Of Co²⁺ in MCM-41 tend to show asymmetric shapes. As mentioned above, the pore wall thickness of Co-MCM-41 is about 1 nm, and the ionic radius of Co is 0.072 nm. Therefore, as discussed above, when Co is incorporated in the framework of MCM-41 to form isolated Co ions, the Co ions can distribute over several layers in the framework. The Co ions may be on the surface, in the interior of the silica wall, or subsurface (between these two locations). Accordingly, the asymmetric reduction peaks may be attributed to the different locations of Co ions in the framework relative to the pore wall.

Three TPR profiles of the Co-MCM-41 samples prepared from different silica sources and different pH values are shown in FIGS. 5(a) to 5(c). As in the analysis of the radius of curvature effect described above, Co ions on the surface, subsurface, and interior silica wall are tentatively assigned as peaks 1, 2, and 3, respectively. The TPR profile recorded for the sample prepared using the Cab-O-Sil silica source with a pH adjustment to 11.5 (FIG. 5(a)) indicates that most Co species appear to be distributed subsurface. However, when the pH was adjusted to approximately 11 (FIG. 5(b)), the Co distribution changes dramatically, resulting in a shift of the maximum reduction rate. The deconvolution of TPR profile recorded for the Co-MCM-41 sample synthesized using the HiSiI 915 (PPG) silica source (FIG. 5(c)), which has a lower purity, suggests that most Co ions are distributed near the surface (peak 1 and 2). These results suggest that the purity of the silica source as well as pH adjustment can affect the Co distribution in the pore walls. However, these complications introduced by low purity silica source and non-reproducible calcinations conditions of Co-MCM-41 can be easily solved by using high purity silica and by calcining a fixed, small amount of as-synthesized sample with a low weight-to-flow rate ratio.

The pH effect on the physical structure of Co-MCM-41 was evaluated by nitrogen physisorption. It was found that the pore diameter, the total pore volume (volume of mesopores and inter particle spaces), and the full width at half maximum (FWHM) of pore size distribution do not change with pH. When mesopore volume, defined as the volume of pores having sizes below 10 ran, is compared separately, it was found to linearly increase with the pH value of the initial synthesis solution. This change in mesopore volumes is compensated by the inter particle spaces, resulting in a constant total pore volume for all samples. These results indicate that pH controls the porosity of the Co-MCM-41 sample, wherein higher pH creates more mesopores of the same size in Co-MCM-41. The density difference between samples with different pH can be readily observed when dried samples are crushed. A sample produced at lower pH was more brittle than a sample produced at high pH. However, the physical properties of all C125 samples deteriorated significantly because of structure collapse, which may be attributed to the excess porosity.

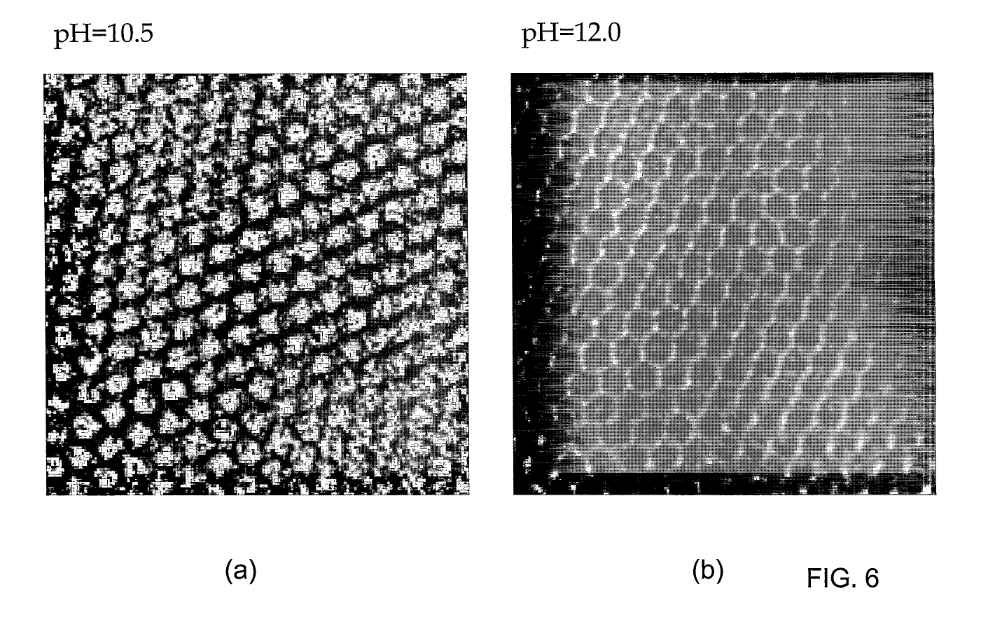

TEM analysis was performed for each Co-MCM-41 sample to check the hexagonal pore structure and calculate the pore wall thickness. FIGS. 6(a) and 6(b) show a TEM of Co-MCM-41 prepared by the aforedescribed process using two different pH values for the initial synthesis solution, looking down the pores, which are ordered in a hexagonal array. While the overall order is similar, the pores are more rounded and less defined at pH=10.5 (FIG. 6(a)), but are essentially of hexagonal shape at pH=12 (FIG. 6(b)). FIG. 6(b) appears to be the first reported direct evidence for an ideal hexagonal pore shape, as well as a hexagonal arrangement of the pores in sufficiently highly structured materials, such as MCM-41.

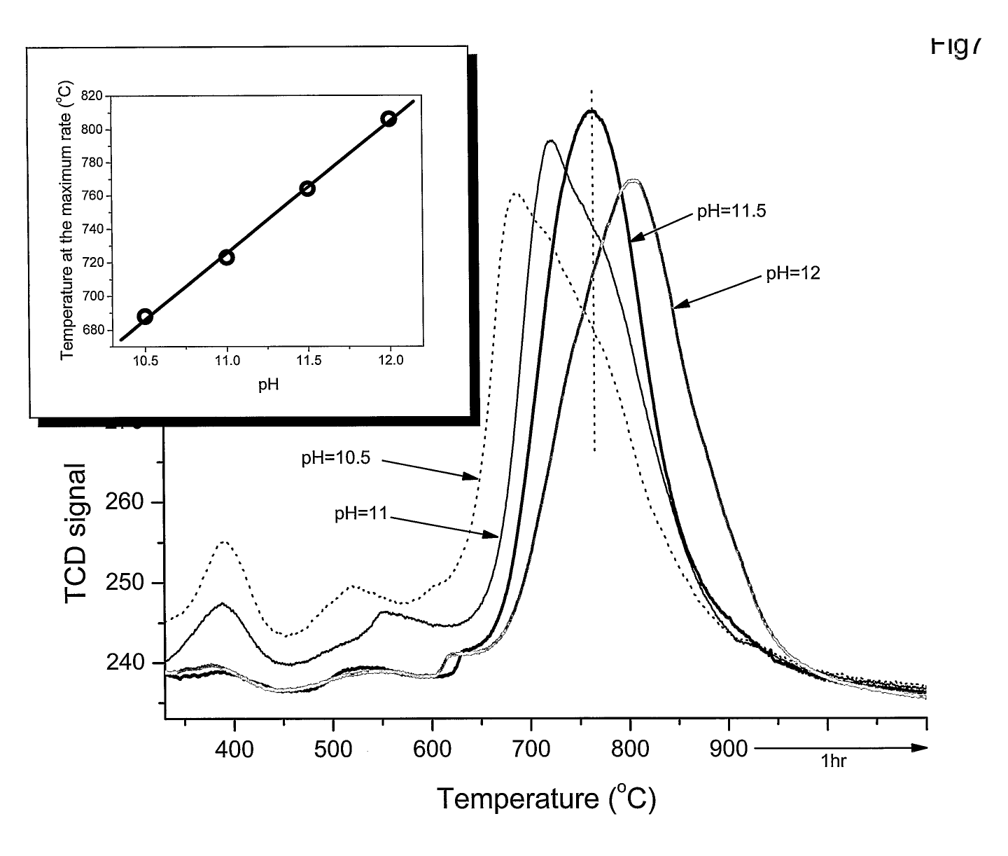

The reduction stability of each Co-MCM-41 sample was evaluated by TPR, with the results illustrated in FIG. 7. The maximum reduction rate shifts to a higher temperature as pH increases. As shown in the inset of FIG. 7, there is a linear relation between pH and the maximum reduction rate. This suggests that pH affects the chemical properties of Co as well as the physical properties of the MCM-41 matrix. The major reduction peak of Co²⁺ in C115 shows a narrow and symmetric shape. However, C105 and C110 have shoulders on the right side of the reduction peak, and C120 has a shoulder on the left side. These shoulders are approximately the same temperature as that of the maximum rate reduction of C115.

These differences in the pattern of reduction may be the of result differences in the distribution of Co ions in Co-MCM-41, as discussed above with reference to FIG. 5. Therefore, a similar deconvolution of each reduction peak with a Gaussian fitting was performed as shown in FIGS. 8(a) to 8(c). FIG. 8(b) for C115 suggests that most Co ions are distributed subsurface resulting in an almost symmetric and narrow reduction peak. The distribution of Co ions changes significantly as pH changes, as emphasized by the inclined arrow; C110 (FIG. 8(a)) has a substantial portion of surface Co ions, and C120 (FIG. 8(c)) has an increased portion of Co ions in the interior of the silica wall. Surface Co ions can be reduced more easily than those in the interior, resulting in a shift of the maximum reduction rate. The shoulders shown in the reduction peaks of C105, C110, and C120 could be the Co ions distributed subsurface, which is the major contribution to C115 reduction.

These results suggest that pH extensively affects the distribution of metal ions in the MCM-41 framework resulting in different reduction stability. As discussed above, changing the pH value of the initial solution does not appear to change the pore size, but rather the pore wall thickness and the number (or area density) of mesoporous pores. This suggests that the reduction stability may be controlled for a fixed pore diameter by adjustment of the initial pH of the synthesis solution. Stated differently, sub-nanometer Co cluster sizes may be controlled without varying the pore radius of curvature.

The Co cluster size produced from samples with different initial synthesis solution pH values was determined from in-situ X-ray absorption experiments (not shown), which suggested that the average first shell Co-Co coordination number decreases linearly with increasing pH. By building a (111)-truncated hemispherical cuboctahedron model, as shown in FIG. 4, the cluster size was estimated to be under 0.3 nm in diameter with several atoms in the cluster. These extremely small metal clusters may be anchored to unreduced Co ions in the framework producing high stability and high dispersion on the surface.

Very highly dispersed Co clusters may be synthesized by controlled reduction of cobalt ions isomorphously substituted for silicon ions in MCM-41. A major controlling factor is the radius of curvature of the pores in the Co-MCM-41 precursor, but several other parameters, such as the reducing agent, pH, time, temperature, impurities and structural order will also affect the reducibility of Co in Co-MCM-41. The total Co loading is also likely to affect both reducibility and final Co cluster size. However, for fixed Co loading, the synthesis conditions used in the preparation of the Co-MCM-41 appear to affect the distribution of the Co in the bulk of the pore wall or near surface, as does the radius of curvature of the pore wall. It appears that the Co distribution moves toward the interior of the wall as the radius of curvature decreases. Similar results are expected for other first-row transition metals, and thus metal-MCM-41 may provide a general method for obtaining highly dispersed and size controllable first-row transition metals in a MCM-41 matrix.

TABLE 2

| | Metal surface | Dispersion | Metal particle | Normalized |
|---|---|---|---|---|
| Catalysts | area (m²/g) | (%) | size (nm) | ratio |
| 1 wt % Co impregnated Si-MCM-41 | 0.32 | 4.05 | 23.85 | 1 |
| 1 wt % Co impregnated pre-reduced | 0.77 | 11.36 | 8.77 | 2.7 |
| 1 wt % Co-MCM-41 | | | | |
| 1 wt % Co impregnated 1 wt % Co-MCM-41 | 0.56 | 8.32 | 11.97 | 2.0 |
| 1 wt % Co impregnated 1 wt % Ti-MCM-41 | 0.66 | 9.71 | 10.26 | 2.3 |

Results obtained with different distributions of Co in the silica framework and with other transition metals (numbers are given for Titanium as an example) are summarized in Table 2. Four different catalysts were prepared, which are listed in column 1. Shown in the different rows are the experimental results for the metal surface area, the dispersion, the metal particle size, and the normalized dispersion ratio. It should be noted that the results in Table 2 were obtained by hydrogen chemisorption, and a comparison with EXAFS data suggests that hydrogen chemisorption tends to underestimate the absolute metal surface area and the metal particle size. However, the trend observed for the dispersion (column 3) and the normalized dispersion ratio (column 5) is independent of the measurement method used. Co metal particles were prepared by impregnation (chemically depositing a salt precursor on the surface of the MCM-41; row 1) as well as by incorporating the Co cations (rows 2 and 3) and Ti (row 4) in the MCM-41 matrix as precursor on MCM-41. In comparison, Co-MCM-41 (row 2) shows a factor of two better dispersion than Co-impregnated MCM-41. Dispersion is further improved by is pre-reducing the Co-MCM-41 at 900° C. for 30 minutes (row 3). When incorporating Ti cations in the MCM-41 (row 4), the Co metal particles are apparently anchored to the Ti⁺⁴ cations in the Ti-MCM-41.

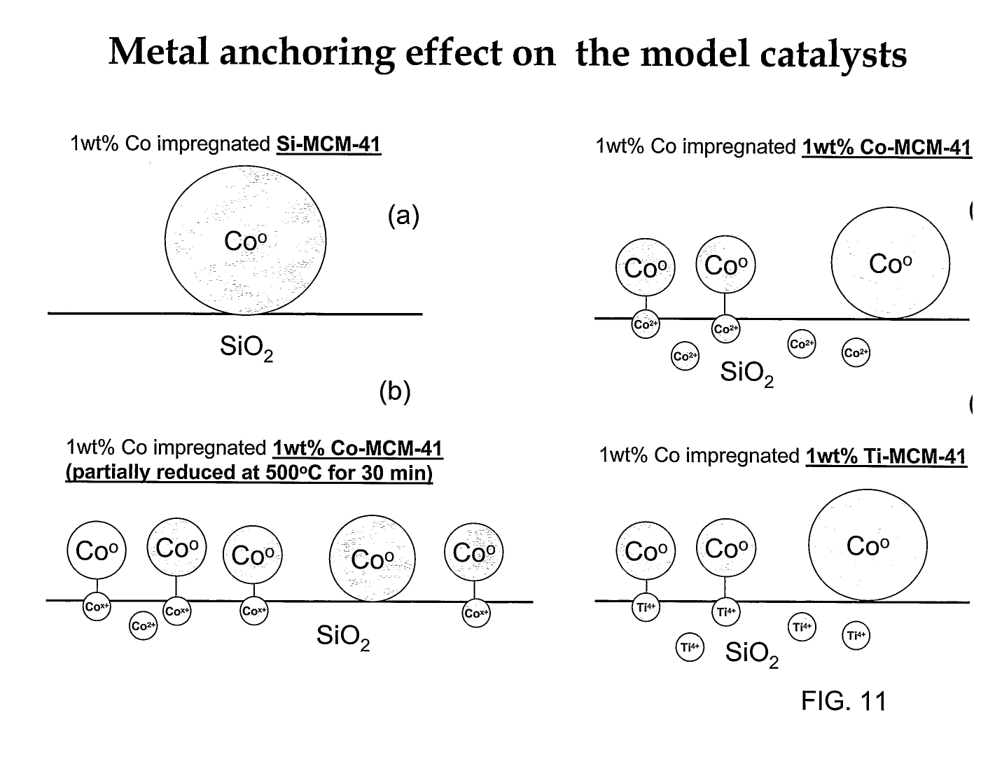

FIG. 11 shows an exemplary pictorial diagram of the size and distribution of Co particles on the surface of metal-ion substituted MCM-41 based on the experimental observations of Table 2. If Co particles are formed by impregnation of a pure silica framework, relatively large Co particles because there would be no Co cations in the silica matrix functioning as anchors (FIG. 11a). Conversely, when the Co- or Ti-cations are incorporated in the MCM-41 matrix as the precursor (FIGS. 11b, c, and d), then small Co metal particles may bond to the Co- or Ti-cations bound in the silica, thereby reducing the particle size of Co formed in the pores.

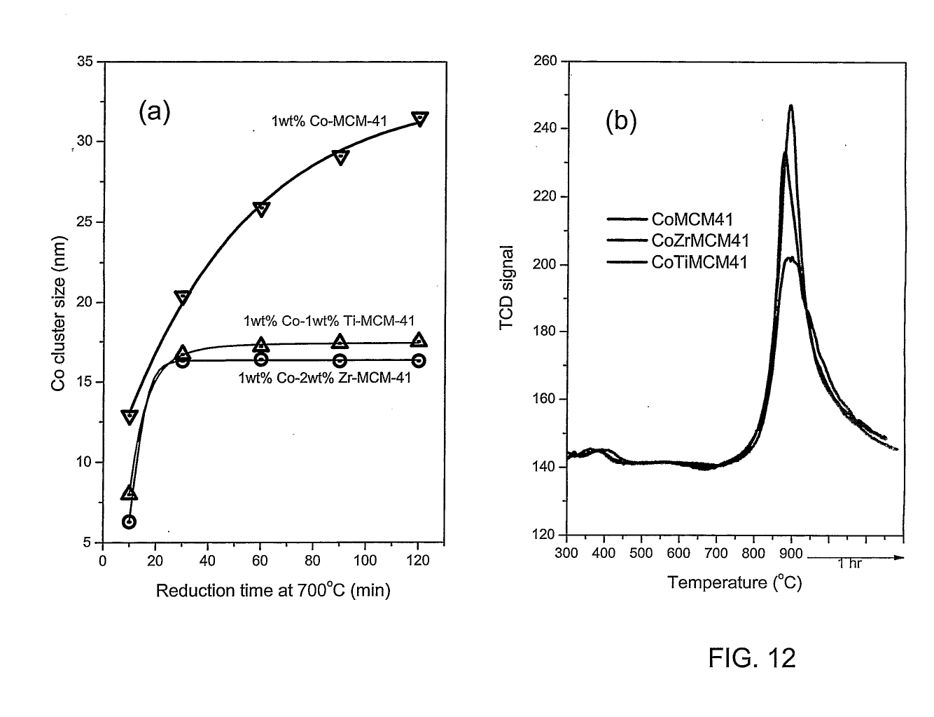

FIG. 12(a) shows the apparent Co metal cluster size (measured by CO chemisorption) as a function of the reduction time. When Co metal particles anchor to Co cations (which are being continually reduced to metal), the cluster size continues to grow with reduction time. However if the MCM-41 is synthesized with both Co and a second, less reducible cation, such at Ti⁺⁴ or Zr⁺⁴, then the metal particle growth of Co appears to be inherently limited after a reduction time of about 30 minutes. FIG. 12(b) shows TPR of the Co in the three different environments and demonstrates that the reducibility (temperature of maximum rate of reduction) is not affected by the presence of a second cation (Ti or Zr) in the MCM-41.

Moreover, adjustment of pH in the initial synthesis solution is an important factor controlling the physical and chemical properties of metal ions incorporated in the MCM-41 matrix. Controlling pH affects the porosity of MCM-41 and the metal ion distribution in the pore wall. For example, increasing pH from 10.5 to 12 produced more porous Co-MCM-41 with higher stability, with more Co ions distributed subsurface and in the interior silica wall creating higher stability against reduction. The size of the Co clusters can therefore be controlled with different reduction conditions, pH, and pore size. This makes it possible to design a highly dispersed, stable metallic clusters of controllable size for specific catalytic reactions.

As described above, several external parameters contribute to the accurate reproduction of Co-MCM-41 catalysts, of which pore diameter, order of the structure, and cobalt content appear to play significant roles. Importantly, cobalt content can be adjusted by careful variation of the synthesis variables without collapse of the basic hexagonal structure.

It is also known that preparation parameters interact with one another, which in turn, influences the reproduction properties (pore diameter, structure, Co content), but this interaction is not known in detail. Accordingly, there is a need for a model which explains how various synthesis parameters contribute to the physical properties and the structure of metal-substituted mesoporous materials, in particular MCM-41.

Methods for a multivariable, quantitative model describing the synthesis of Co-MCM-41 will now be described. The proposed model is based on selection of five independent synthesis variables for the exemplary composition Co-MCM-41, although the model can have a different number of variables and can also be applied to other metal substitutions and possible other frameworks.

As described above and also, for example in WO 2003/052182, several parameters have been observed to influence the synthesis of Co-MCM-41. Of those parameters, five (5) parameters X₁, . . . , X₅ have been found to have the strongest influence after pH has been optimized: alkyl chain length; initial cobalt concentration; surfactant-to-silica ratio; TMA-to-silica ratio; and water-to-silica ratio. The results from the multivariable analysis of the Co-MCM-41 are three physical quantities y₁, y₂, and y₃: pore diameter; metal composition; and structural order (as determined from the slope of capillary condensation). The ranges of the input parameters X₁, . . . , X₅ and the resulting physical quantities y₁, y₂, y₃ are summarized in Table 3 below:

TABLE 3

| Synthesis variable | Level |
|---|---|
| xᵢ: Alkyl chain length, # of carbon | 10, 12, 14, 16 |
| x₂: Initial cobalt concentration, wt. % | 0.5, 1.0, 2.0, 3.0 |
| x₃: Surfactant-to- silica ratio | 0.14, 0.27, 0.54 |
| x₄: TMA-to-silica ratio | 0.15, 0.29, 0.58 |
| x₅: Water-to- silica ratio | 70.0, 86.0, 100.0 |
| y₁: Pore diameter, nm | 1.72-2.96 |
| y₂: Metal composition, wt. % | 0.55-3.38 |
| y₃: Structural order (slope of capillary | 0-5113.9 |
| condensation step) | |

x₂, x₃, x₄ and x₅ are given as molar ratios of the additives relative to total silica

The model is based on a statistical analysis of the experimental data. A total of 28 experiments were performed, with the samples consecutively numbered from 1 through 28. The synthesis parameters used in each of the experiments and the measured physical quantities for each experiment are listed in Table 4 below:

TABLE 4

| ID | x₁ | x₂ | x₃ | x₄ | x₅ | y₁ | y₂ | y₃ |
|---|---|---|---|---|---|---|---|---|
| Co01 | 16 | 1.0 | 0.54 | 0.29 | 70 | 2.87 | 1.08 | 5113.9 |
| Co02 | 16 | 3.0 | 0.14 | 0.15 | 86 | 2.92 | 3.00 | 750.4 |
| Co03 | 16 | 0.5 | 0.54 | 0.58 | 100 | 2.34 | 0.60 | 1745.6 |
| Co04 | 16 | 1.0 | 0.27 | 0.15 | 86 | 2.94 | 1.08 | 2323.3 |
| Co05 | 16 | 2.0 | 0.27 | 0.58 | 100 | 2.57 | 2.14 | 3090.9 |
| Co06 | 16 | 2.0 | 0.14 | 0.29 | 86 | 2.93 | 2.13 | 4675.6 |
| Co07 | 16 | 0.5 | 0.27 | 0.15 | 70 | 2.96 | 0.55 | 1917.1 |
| Co08 | 14 | 0.5 | 0.27 | 0.29 | 70 | 2.57 | 0.57 | 4035.2 |
| Co09 | 14 | 3.0 | 0.14 | 0.29 | 100 | 2.57 | 3.15 | 2057.0 |
| Co10 | 14 | 2.0 | 0.14 | 0.15 | 86 | 2.62 | 2.07 | 1001.8 |
| Co11 | 14 | 0.5 | 0.54 | 0.15 | 100 | 2.69 | 0.57 | 1344.0 |
| Co12 | 14 | 1.0 | 0.27 | 0.29 | 86 | 2.57 | 1.11 | 3620.0 |
| Co13 | 14 | 1.0 | 0.54 | 0.58 | 70 | 2.13 | 1.16 | 1587.4 |
| Co14 | 14 | 3.0 | 0.54 | 0.58 | 86 | 2.47 | 3.30 | 3180.8 |
| Co15 | 14 | 2.0 | 0.27 | 0.29 | 100 | 2.62 | 2.13 | 2773.8 |
| Co16 | 12 | 3.0 | 0.54 | 0.15 | 86 | 2.25 | 3.22 | 273.5 |
| Co17 | 12 | 1.0 | 0.27 | 0.15 | 100 | 2.27 | 1.10 | 686.0 |
| Co18 | 12 | 0.5 | 0.14 | 0.58 | 100 | 2.18 | 0.65 | 2337.6 |
| Co19 | 12 | 2.0 | 0.27 | 0.15 | 100 | 2.21 | 2.18 | 496.5 |
| Co20 | 12 | 2.0 | 0.14 | 0.58 | 86 | 2.18 | 2.30 | 2965.8 |
| Co21 | 12 | 3.0 | 0.14 | 0.58 | 100 | 2.19 | 3.38 | 1716.8 |
| Co22 | 10 | 3.0 | 0.14 | 0.15 | 100 | 1.72 | 3.23 | 0.0 |
| Co23 | 10 | 0.5 | 0.54 | 0.29 | 100 | 1.88 | 0.59 | 1543.0 |
| Co24 | 10 | 1.0 | 0.54 | 0.15 | 70 | 1.86 | 1.11 | 421.6 |
| Co25 | 10 | 3.0 | 0.54 | 0.29 | 86 | 1.87 | 3.22 | 566.8 |
| Co26 | 10 | 1.0 | 0.27 | 0.58 | 86 | 1.75 | 1.26 | 1589.5 |
| Co27 | 10 | 2.0 | 0.14 | 0.15 | 100 | 1.74 | 2.19 | 306.9 |
| Co28 | 10 | 0.5 | 0.27 | 0.58 | 70 | 1.75 | 0.61 | 1569.2 |

The multivariable analysis is based on the following equations:

$${y}_{k} = {\sum }_{i = 1}^{5} {a}_{i}^{*} {x}_{i} + {\sum }_{{K}_{j = 2}}^{5} {b}_{i , .}^{k} / {x}_{i} {x}_{j} with k = 1 , 2 , 3$$

A standard statistical software package, such as JMP version 4.0.4, is used to analyze the correlation of the synthesis variables. Three-factor effects are ignored, i.e., only the main variables and two-factor interaction terms that are statistically significant are taken into account. All the independent variables and response variables are normalized by setting the mean value to 0 and the standard deviation to 1.

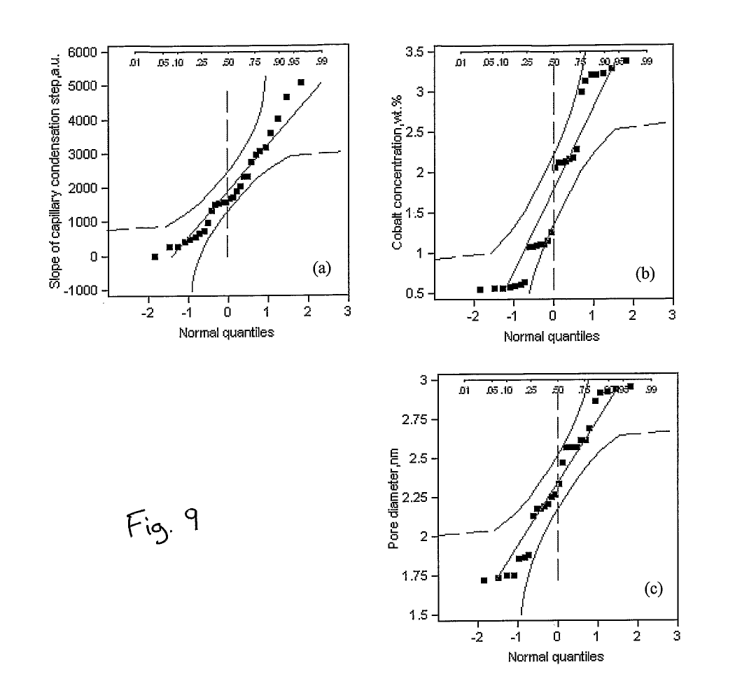

Normality is important with respect to statistical analysis because non-normality can affect the interpretation of the results (e.g., it can affect the loadings). If the variable is highly skewed, then the relative importance of this component may be exaggerated or ignored, even after standardizing. In the present embodiment, normality was assessed by means of the Normal Quantile-Quantile plot or Q-Q plot shown in FIG. 9. The y-axis of the Normal Q-Q plot shows the actual values and the x-axis shows the expected normal scores for each value. If a variable is normal, then the normal Q-Q plot approximates a diagonal straight line. The distribution of the response variables in FIG. 9 indicates interpretable data.

Correlation coefficients are objective and qualitative measures of synthesis parameter pair-wise interaction. Correlation coefficients give the sample correlation between two sets of variable, i.e., one set of independent variables and one set of dependent variables.

The correlation coefficient is defined by:

$$r = \frac{\sum ( {x}_{1 i} - {\overline{x}}_{1} ) ( {x}_{2 i} - {\overline{x}}_{2} )}{\sqrt{\sum {( {x}_{1 i} - {\overline{x}}_{1} )}^{2}} \sqrt{\sum {( {x}_{2 i} - {\overline{x}}_{2} )}^{2}}} = \frac{\sum ( {x}_{1 i} - {\overline{x}}_{1} ) ( {x}_{2 i} - {\overline{x}}_{2} )}{{s}_{{X}_{1}} {s}_{{X}_{2}} ( n - 1 )}$$

A correlation matrix, made up of correlation coefficients, provides a way of easily comparing correlations. A correlation matrix is a square, symmetric matrix, with diagonal entries equaling 1. Because matrix entries are normalized, correlations are comparative. That is, matrix entries are not dependent on the units of the original data because they exhibit the same upper and lower bounds of +1 and −1, regardless of the variables.

TABLE 5

| | x₁ | x₂ | x₃ | x₄ | x₅ | y₁ | y₂ | y₃ |
|---|---|---|---|---|---|---|---|---|
| x₁ | 1.0000 | — | — | — | — | — | — | — |
| x₂ | −0.0791 | 1.0000 | — | — | — | — | — | — |
| x₃ | −0.0224 | −0.2424 | 1.0000 | — | — | — | — | — |
| x₄ | −0.0198 | −0.0986 | 0.0395 | 1.0000 | — | — | — | — |
| x₅ | −0.1294 | 0.2943 | −0.2646 | −0.0189 | 1.0000 | — | — | — |
| y₁ | 0.9262 | −0.0324 | −0.1049 | −0.2453 | −0.1342 | 1.0000 | — | — |
| y₂ | −0.1143 | 0.9974 | −0.2378 | −0.0533 | 0.3011 | −0.0729 | 1.0000 | — |
| y₃ | 0.5756 | −0.2338 | −0.0346 | 0.3446 | −0.2765 | 0.5604 | −0.2313 | 1.0000 |

The correlation matrix for the exemplary Co-MCM-41 samples is shown in Table 5. Intuitively, one would expect a large correlation between alkyl chain length and pore diameter. Similarly, a large correlation may be expected between cobalt source concentration and cobalt loading in the resulting Co-MCM-41.

As seen in Table 5, the surfactant alkyl chain length (x₁) has a significant positive influence on the formation of Co-MCM-41; the longer the alkyl chain, the better the Co-MCM-41 structure, indicated by the correlation between variable X₁ and y₃. The surfactant alkyl chain length (x₁) also dominates the pore diameter (y{) because longer alkyl chain length forms a larger micelle template. However, surfactant alkyl chain length does not have a strong correlation with the final cobalt concentration incorporated in the silica framework (y₂). This observation applies to Co-incorporation in MCM-41, and is different, for example, for Vanadium (not shown) in which the alkyl chain length has a significant effect on the vanadium incorporation. Nevertheless, a similar model, albeit with different sets of parameters, is expected to apply.

The correlation between the initial cobalt concentration (x₂) in the synthesis solution and final cobalt loading (y₂) is almost equal to 1. This indicates that most of the cobalt is incorporated into the silica framework of MCM-41. It is noted that this correlation does not occur if HiSil-915 silica is used as the colloidal silica source. In that case, only 60% of the cobalt was incorporated. As discussed above with reference to FIG. 5, the major difference between the Cab-O-Sil silica and the HiSil-915 silica is the impurity level. The Cab-O-Sil is almost pure silica (99.8 wt. %) and HiSil-915 has a major impurity of 0.5wt. % sodium sulfate.

The initial cobalt concentration (x₂) has a slightly negative influence on the pore diameter, which can be found from the correlation coefficient −0.0324. The pores of MCM-41 may be partially blocked by the incorporation of an excess amount of cobalt. In the present embodiment, the small correlation coefficient indicates the substitution of cobalt species does not significantly affect the siliceous structure.

The amount of surfactant relative to the silicon source (x₃) seems to have little influence on the structural order. Viscosity of the solution increases with higher surfactant concentration, which results in the poor incorporation of cobalt (y₂) and the negative correlation coefficient.

The content of TMA silica (x₄) has little to do with the metal loading in the framework, which can be demonstrated by the correlation coefficient −0.0533. However, content of TMA silica (x₄) influences the physical structure and pore diameter. In particular, higher TMA content is good for the formation of porous materials. TMA is a soluble organic silica. Accordingly, TMA enhances the solubility of the silica source and reduce the possibility of agglomeration, which can promote the building of the physical structure of Co-MCM-41. The TMA source can accelerate the crystallization of silica because of its higher solubility.

In addition, TMA can have a kinetic effect for the following reason. TMA is more reactive than inorganic oligomers which produces a kinetically driven “virtual pressure.” The virtual pressure results in a smaller pore.

The addition of water appears to enhance the incorporation of Co as evidenced by the correlation coefficient 0.3011.

As mentioned earlier, structural order, pore diameter, and Co loading interact with each other. Structural order (y₃) is affected by pore size (y₁). That is, samples with a larger pore diameter have a better structure. At the same time, the negative correlation coefficient between the metal loading and structural order indicates that the more incorporation of cobalt will reduce the long-range order of Co-MCM-41 catalysts.

A primary goal is to be able to vary the pore diameter while maintaining a constant composition and structure. Theoretically, when the radius of curvature is changed, the stability of Si-O-Co units in the pore wall is affected so that, all other variables being held constant, the amount of Co incorporated also varies. However, the correlation between pore diameter and final Co loading is small. This confirms the experimental observation that the pore diameter can be controlled independent of metal composition.

Correlations for structure, pore diameter, and Co concentration are performed separately. The following empirical equations can then be used to model the physical quantities y₁, y₂, and y₃ as a function of the aforedescribed experimental input parameters X₁, . . . , X₅.

γ₁=0.037+0.951.T₁+0.045 X₂−0.023x₃−0.239 X₄+0.016.V₅+0.06Sx ₁X₂+0.00Ox ₁X₃−0.14S x₁X₄−0.034X ₁X₅+0.069 X₂X₃+0.112X,X ₄−0.022X ₂X₅−0.124X ₃X₄+0.00SX ₃X₅−0.017 X_{4X5}

γ₂=0.003−0.039.T₁+0.99Sx ₂−0.005X₃+0.045X₄−0.002x ₅−0.02Ox ₁X₂+0.0013 X₁X₅−0.002X₁X₄−0.004X ₁X₅+0.003X ₂X₃+0.025x,x ₄−0.009.X₂X₅−0.00Sx ₃X₄−0.004 χ₃X₅−0.002x ₄τ₅

γ₃=0.046÷0.684X ₁−0.105 X₂−0.16Sx ₃+0.42Ox₄−0.26I x₅+0.172 X₁X₂+0.01Sx ₁X₃÷0.30Ox₁X₄−0.30O x₁X₅+0.126x,x ₃+0.14Ix ₂X₄+0.05Ix ₂X₅−0.3S4x ₃x₄+0.0095x _{}}x₅−0.165 X₄χ₅

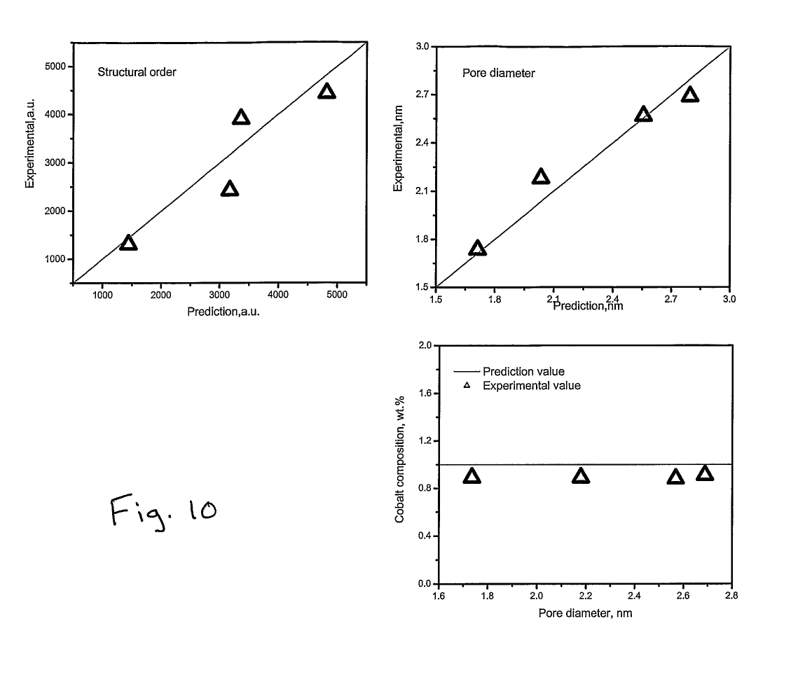

The predictive synthesis model was confirmed by preparing and analyzing four samples with a predicted highly ordered structure, different pore diameters, but identical cobalt loading. FIG. 10 shows diagrams comparing the experimental results with the predicted values for the four samples. As seen in FIG. 10, the synthesis model substantially predicts the structure and pore diameter of Co-MCM-41 samples, as well as the cobalt loading in samples with different pore diameters.

The disclosed catalysts can be used in industrial processes, for example, for reforming methane to hydrogen, and for water gas shift and CO methanation reactions.

The process for reforming methane to hydrogen by steam and CO₂ operates as follows:

CH₄+H₂O→CO+3H₂, or CH₄+2H₂O→CO₂+4H₂

CH₄+CO₂→2CO+2H₂

CH₃OH→CO+2H₂ or CH₃OH+H₂O→CO₂+3H₂.

These reaction are not completely selective to CO₂ so that some CO is always formed. In a subsequent reaction, typically by using a different catalyst and a different reaction temperature, CO can be transformed to form additional hydrogen by the water gas shift reaction,

CO+H₂O→CO₂+H₂.

The Ni catalysts used in conventional processes for the gas-phase reforming of methane have been found to be susceptible to carbon formation (coking). Co and Ni-based catalysts (Co-MCM-41 and Ni-MCM-41) prepared according to the aforedescribed invention have a very high area and are supported on structured silica to stabilize the dispersion under severe reaction conditions. Tests by the inventors of Ni-MCM-41 with embedded Ni particles for methane reforming showed stable activity and resistance to coking. Moreover, Cu-modified MCM-41 has been tested as a catalyst for dehydrogenation. High and stable methanol dehydrogenation activity was noted for the catalyst showing highly dispersed Cu and Cu²⁺ ions strongly interacting with the support. The state/size of the Cu species can be manipulated using both the anchoring and radius of curvature effects described above. For example, smaller size (about 7 nm) particles can delay the onset of carbon formation by 373° C. as compared to larger particles (about 102 nm) and show a reaction rate which is about 3% of that of the larger particles.

While the invention has been disclosed in connection with the preferred embodiments shown and described in detail, various modifications and improvements thereon will become readily apparent to those skilled in the art. For example, other metal ion, such as Ti, V, Cr, Mn, Fe, Co, and Ni could be incorporated in the MCM-41 framework. The invention is also not limited to MCM-41, and other mesoporous siliceous frameworks selected, for example, from the Mobil M41S class materials, which also includes MCM-48. Another class of mesostructured materials can include alumina compounds, such as 7-Al₂O₃, as described, for example, by Zhang et al. in J. Am. Chem. Soc. Vol. 124, No. 8, pp. 1592-1593 (2002). Accordingly, the spirit and scope of the present invention is to be limited only by the following claims.

What is claimed is:

1-20. (canceled)

21. A method for producing a mesoporous structure comprising the steps of:
preparing an aqueous solution by mixing in combination colloidal silica and a soluble silica salt and at least two metal precursors, said at least two metal precursors having different reduction kinetics,
drying and calcining the solution in an inert gas to form the mesoporous structure having pores,
exposing the mesoporous structure to a reducing atmosphere, thereby causing a different degree of reduction of the metal precursors, with metal ions from a more reducible precursor being anchored in the pores to metal ions of a less reducible precursor, thereby forming catalytic sites of highly dispersed metal clusters.

22. The method of claim 21, wherein the mesoporous structure is a siliceous structure selected from the M41S class of materials.

23. The method of claim 21, wherein the at least two metal precursors comprise metal ions selected from the first row transition metals or from the group VIII of the periodic system.

24. The method of claim 21, wherein the at least two metal precursors comprise metal ions selected from the group consisting of Cu, Ti, V, Cr, Mn, Fe, Co, and Ni.

25. The method of claim 21, wherein the less reducible metal precursor comprises at least one of Ti and Zr, and the more reducible metal precursor comprises at least one of Fe, Ni and Co.

26. The method of claim 21, further comprising adjusting a reduction rate of the metal ions by producing the mesoporous structure with a predetermined pore radius of curvature.

27. A mesoporous structure with highly dispersed transition-metal catalytic sites in pores of the mesoporous structure produced with the method according to claim 21.

28. Use of an oxide structure produced with the method according to claim 21 in chemical catalysis, in particular hydrocarbon reforming.
